(19) United States
(12) Patent Application Publication
(10) Pub. No.: US 2025/0003763 A1
(43) Pub. Date: Jan. 2, 2025

(54) CHARGING STATION INFORMATION PROVIDING SERVER AND METHOD, AND CHARGING STATION INFORMATION PROVIDING APPLICATION

(71) Applicant: TBU INC., Seoul (KR)

(72) Inventors: Sang Jin PAIK, Seoul (KR); Jung Gwon SHIN, Gyeonggi-do (KR)

(73) Assignee: TBU INC., Seoul (KR)

(21) Appl. No.: 18/709,517

(22) PCT Filed: Jul. 28, 2022
(86) PCT No.: PCT/KR2022/011125

§ 371 Date: May 13, 2024

(30) Foreign Application Priority Data
Nov. 12, 2021 (KR) 10-2021-0155986

(51) Int. Cl. G01C 21/36; G01C 21/00; G01C 21/34

(52) U.S. Cl. CPC G01C 21/3679; G01C 21/3407; G01C 21/3469; G01C 21/3476; G01C 21/3626; G01C 21/3667; G01C 21/3885

(57) ABSTRACT

A charging station information providing server receives a charging station recommendation request from an external device, generates, in response to the received charging station recommendation request, a charging station recommendation query based on user information and vehicle information corresponding to a user of the external device, obtains customized recommended charging station information based on charging station list information obtained by using a charging station evaluation model, and road condition information, by using a charging station recommendation model that takes the generated charging station recommendation query as input, and transmits the obtained customized recommended charging station information to the external device.

### TECHNICAL FIELD

The present disclosure relates to a charging station information providing server and method, and a charging station information providing application.

### BACKGROUND ART

The electric vehicle market is rapidly increasing day by day due to the rapidly growing demand for electric vehicles. Nevertheless, electric vehicle charging infrastructure is insufficient, and there are difficulties in supplying a sufficient number of charging stations due to regional characteristics and construction environment characteristics.

When a user drives a vehicle to a nearby charging station to use a public charging station or a charging station operated by a charging station operator, the circumstances of the charging station or the number of drivers waiting to use the charging station may result in the charging station being unavailable due to a charger failure or the user having to use another charging station due to a long waiting time.

### DISCLOSURE

### Technical Problem

Provided are a charging station information providing server and method for providing customized recommended charging station information, and a charging station information providing application.

### Technical Solution

A charging station information providing server according to a first aspect includes a storage, a communication interface unit, a memory storing instructions, and a processor configured to execute the instructions to receive a charging station recommendation request from an external device through the communication interface unit, generate, in response to the received charging station recommendation request, a charging station recommendation query based on user information and vehicle information stored in the storage and corresponding to a user of the external device, obtain customized recommended charging station information based on charging station list information obtained by using a charging station evaluation model, and road condition information, by using a charging station recommendation model that takes the generated charging station recommendation query as input, and transmit the obtained customized recommended charging station information to the external device through the communication interface unit.

A charging station information providing method performed by a charging station information providing server according to a second aspect includes receiving a charging station recommendation request from an external device, generating, in response to the received charging station recommendation request, a charging station recommendation query based on user information and vehicle information corresponding to a user of the external device, obtaining customized recommended charging station information based on charging station list information obtained by using a charging station evaluation model, and road condition information, by using a charging station recommendation model that takes the generated charging station recommendation query as input, and transmitting the obtained customized recommended charging station information to the external device.

A charging station information providing application stored in a medium according to a third aspect to cause at least one processor of a terminal device to perform a charging station information providing method including detecting an input of a charging station recommendation request in a user interface upon execution of a charging station information providing application, transmitting the charging station recommendation request to a charging station information providing server, receiving, from the charging station information providing server, in response to the transmitting, customized recommended charging station information obtained based on charging station list information obtained by using a charging station evaluation model, and road condition information, by using a charging station recommendation model that takes, as input, a charging station recommendation query based on user information and vehicle information corresponding to a user of the terminal device, and modifying and outputting the user interface based on the received customized recommended charging station information.

### DESCRIPTION OF DRAWINGS

FIG. 1 is a diagram for describing a service environment for providing charging station information.

FIG. 2 is a diagram for describing a configuration and an operation of a vehicle.

FIG. 3 is a diagram for describing a configuration and an operation of a user terminal.

FIG. 4 is a diagram for describing a configuration and an operation of a charging station information providing server.

FIG. 5 is a diagram for describing a process of providing customized recommended charging station information in response to a charging station recommendation request.

FIG. 6 is a diagram for describing a process of obtaining customized recommended charging station information.

FIG. 7 is a diagram illustrating an example of registering user information and vehicle information on a user interface upon execution of a charging station information providing application.

FIG. 8 is a diagram illustrating an example of providing customized recommended charging station information in response to a charging station recommendation request in a user interface upon execution of a charging station information providing application.

FIG. 9 is a diagram illustrating an example of confirming customized recommended charging station information for each category corresponding to charging station type information in a user interface upon execution of a charging station information providing application.

FIG. 10 is a diagram illustrating an example of checking detailed information of customized recommended charging station information in a user interface upon execution of a charging station information providing application.

FIG. 11 is a flowchart of a charging station information providing method upon execution of a charging station information providing application of a terminal device.

FIG. 12 is a flowchart of a charging station information providing method performed by a charging station information providing server.

### MODE FOR INVENTION

Hereinafter, various embodiments will be described in detail with reference to the drawings. In order to more clearly describe the characteristics of the embodiments, detailed description of matters widely known to those of skill in the art to which the following embodiments belong will be omitted.

In addition, throughout the present specification, when an element is referred to as being “connected to” another element, it may be “directly connected to” the other element or may be “connected to” the other element through an intervening element. Furthermore, when an element is referred to as “including” another element, the component may additionally include other elements rather than excluding other elements as long as there is no particular opposing recitation.

In addition, although the terms such as ‘first’ or ‘second’ may be used herein to describe various elements, these elements should not be limited by these terms. These terms are only used to distinguish one element from another element.

In addition, in the present specification, the term ‘charging station recommendation’ refers to providing a user with a customized charging station recommendation result that reflects the states or characteristics of users, vehicles, charging stations, roads, and the like based on various pieces of context information about the users, vehicles, charging stations, roads, and the like, and thus, the technical features of the present specification may also be used for ‘charging station search’. Those of skill in the art to which embodiments disclosed herein are pertain would understand that various modifications are possible, for example, providing a customized charging station search result based on various pieces of context information about users, vehicles, charging stations, roads, and the like in addition to particular search condition information for charging station search. Thus, hereinafter, as used herein, the term ‘charging station recommendation’ may be replaced with ‘charging station search’ or ‘charging station search and recommendation’. For example, the term ‘charging station recommendation request’ may be replaced with ‘charging station search request’ or ‘charging station search and recommendation request’. The term ‘charging station recommendation query’ may be replaced with ‘charging station search query’ or ‘charging station search and recommendation query’. The term ‘charging station recommendation model’ may be replaced with ‘charging station search model’ or ‘charging station search and recommendation model’.

Embodiments of the present embodiment relate to a charging station information providing server and method, and a charging station information providing application, and detailed descriptions of matters widely known to those of skill in the art to which the following embodiments pertain will be omitted.

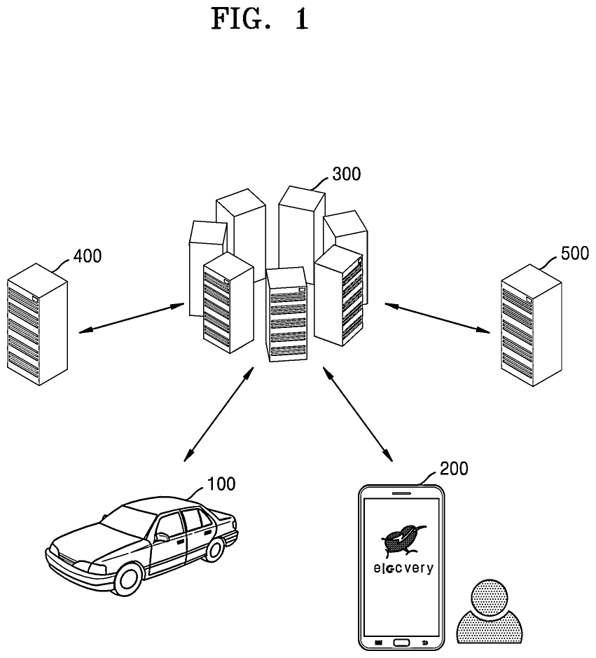

FIG. 1 is a diagram for describing a service environment for providing charging station information.

A vehicle 100 refers to a means of transportation or movement equipped with a rechargeable battery device. For example, the vehicle 100 may be an electric vehicle, a hybrid car, an electric scooter, an electric kick scooter, an electric two-wheeled vehicle, or the like capable of electric charging. The vehicle 100 may operate by appropriately distributing power of the battery device to where power supply is needed in the vehicle 100. When power is supplied from the battery device to each part of the vehicle 100, the battery device is discharged and needs to be charged.

A user terminal 200 is a terminal device of a user who owns or uses the vehicle 100, and may request a charging station information providing server 300 to provide charging station information. To this end, the user terminal 200 may have a charging station information providing application installed thereon. The charging station information providing application may be installed on an external device such as the user terminal 200 or the vehicle 100, but for convenience of description, an example will be described in which the charging station information providing application is installed on the user terminal 200. When the charging station information providing application is executed, a home screen indicating services or functions supported by the application may be output, or a map-based user interface may be output. The map-based user interface may visually show at least one charging station in an area corresponding to a current location or a location recently set by the user. The user may execute the charging station information providing application on the user terminal 200 to request, from the charging station information providing server 300, customized recommended charging station information and route guidance to a particular charging station.

The charging station information providing server 300 may provide information about a charging station. In response to a request received from the vehicle 100 or the user terminal 200, the charging station information providing server 300 may provide information corresponding to the request. The charging station information providing server 300 may collect information about charging stations, road condition information, user information, vehicle information, and the like. The charging station information providing server 300 may transmit, to the vehicle 100 or the user terminal 200, the collected information or information obtained based on the collected information. The charging station information providing server 300 may be implemented with technology such as cloud computing.

A road information providing server 400 may be a server for providing road condition information. The road information providing server 400 may be connected to the charging station information providing server 300 to provide road condition information such as detailed road information or traffic information for determining the state of a travel route from a certain location to a charging station.

A charging station operator server 500 may be a server for transmitting information about a charging station to the charging station information providing server 300. However, the charging station operator server 500 is not limited to its name, and may be another type of server such as an information intermediation server capable of collecting and transmitting information about a charging station. When charging station status information, such as charger usage status, changes according to the use of the charging station, the charging station operator server 500 may transmit the changed charging station status information to the charging station information providing server 300.

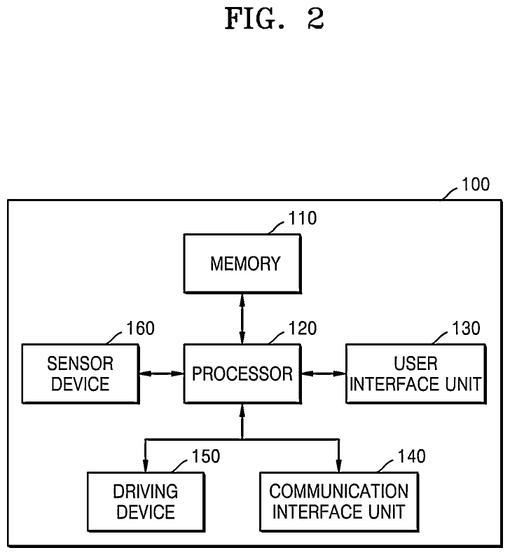

FIG. 2 is a diagram for describing a configuration and an operation of the vehicle 100.

Referring to FIG. 2, the vehicle 100 includes a memory 110, a processor 120, a user interface unit 130, a communication interface unit 140, a driving device 150, and a sensor device 160. Those of skill in the art to which the present disclosure pertains may understand that other general-purpose components may be further included in addition to the components illustrated in FIG. 2.

The memory 110 may store software and/or a computer program. The memory 110 may store instructions executable by the processor 120. The processor 120 may access and use data stored in the memory 110 or store new data in the memory 110. The processor 120 may execute the instructions stored in the memory 110. The processor 120 may include at least one processing module.

The user interface unit 130 may include an input unit for receiving an input from a user such as a driver, and an output unit for providing information. The input unit may receive various types of inputs from the user, and the output unit may include a display panel and a controller for controlling the display panel. The user interface unit 130 may be provided in the form of a touch screen in which a display panel and a touch panel are combined with each other.

The communication interface unit 140 may perform communication with other devices or a server. To this end, the communication interface unit 140 may include a communication module that supports at least one of various communication methods. For example, the communication interface unit 140 may be connected to the user terminal 200 or the charging station information providing server 300 located outside the vehicle 100, to transmit and receive data or information.

The driving device 150 may include a brake, an accelerator, a steering device, a battery device, a driving motor, a transmission, and the like.

The sensor device 160 may include a sensor configured to detect information about an environment in which vehicle 100 is located, and one or more actuators configured to adjust the position or orientation of sensors. According to an embodiment, the sensor device 160 may include, but is not limited to, at least one of a global positioning system (GPS), a camera, an inertial sensor, an acceleration sensor, a geomagnetic sensor, a temperature sensor, a humidity sensor, a barometric sensor, a distance sensor, a speed sensor, an inertial measurement unit (IMU), a radar device, and a lidar device.

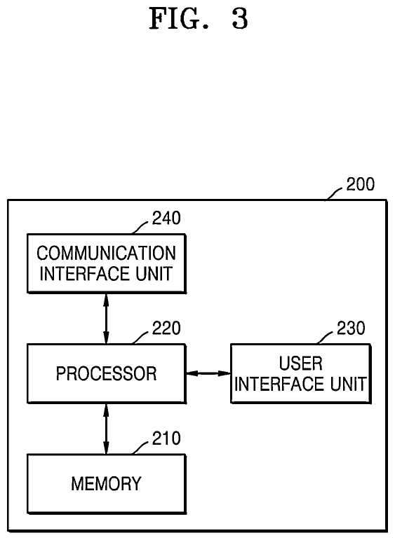

FIG. 3 is a diagram for describing a configuration and an operation of the user terminal 200.

Referring to FIG. 3, the user terminal 200 includes a memory 210, a processor 220, a user interface unit 230, and a communication interface unit 240. Those of skill in the art to which the present disclosure pertains may understand that other general-purpose components may be further included in addition to the components illustrated in FIG. 3. For example, the user terminal 200 may further include a location sensor such as a GPS to obtain current location information.

The memory 210 may store software and/or a computer program. For example, the memory 210 may store programs such as applications or application programming interfaces (APIs), and various types of data. The memory 210 may store instructions executable by the processor 220.

The processor 220 may access and use data stored in the memory 210 or store new data in the memory 210. The processor 220 may execute the instructions stored in the memory 210. The processor 220 may execute an application installed on the user terminal 200.

The processor 220 may include at least one processing module. The processor 220 may control other components included in the user terminal 200 to perform an operation corresponding to a result of executing instructions, a computer program, or the like.

The user interface unit 230 may include an input unit for receiving an input from a user, and an output unit for providing information. The input unit may receive various types of inputs from the user and may include at least one of a keypad, a touch panel, and a pen recognition panel. The output unit may include a display panel and a controller for controlling the display panel, and may be implemented in various forms such as a liquid-crystal display (LCD), an organic light-emitting diode (OLED) display, an active-matrix OLED (AM-OLED) display, or a plasma display panel (PDP). The display panel may be implemented to be flexible or wearable. The user interface unit 230 may be provided in the form of a touch screen in which a display panel and a touch panel are combined with each other.

The communication interface unit 240 may perform wired/wireless communication with other devices or a network. To this end, the communication interface unit 240 may include a communication module that supports at least one of various wired/wireless communication methods. For example, the communication interface unit 240 may include a communication module configured to perform short-distance communication such as Wireless Fidelity (Wi-Fi) or Bluetooth, various types of mobile communication such as 3^{th} Generation (3G), 4^{th} Generation (4G) or 5^{th} Generation (5G), or ultra-wideband communication. The communication interface unit 240 may be connected to the vehicle 100 or the charging station information providing server 300 located outside the user terminal 200, to transmit and receive various types of information or messages containing data.

The processor 220 may execute the instructions stored in the memory 210 to perform the following operations. According to an embodiment, the processor 220 may detect an input of a charging station recommendation request in a user interface upon execution of a charging station information providing application, and transmit the charging station recommendation request to the charging station information providing server 300. For example, the processor 220 may transmit, to the charging station information providing server 300, a charging station recommendation request including at least one of user identification information and vehicle identification information, or transmit, to the charging station information providing server 300, a charging station recommendation request further including condition information for customized recommendation. In response to the transmitting of the charging station recommendation request, the processor 220 may receive, from the charging station information providing server 300, customized recommended charging station information obtained based on charging station list information obtained by using a charging station evaluation model, and road condition information, by using a charging station recommendation model that takes, as input, a charging station recommendation query based on user information and vehicle information corresponding to the user of the user terminal 200. The processor 200 may modify and output the user interface based on the received customized recommended charging station information.

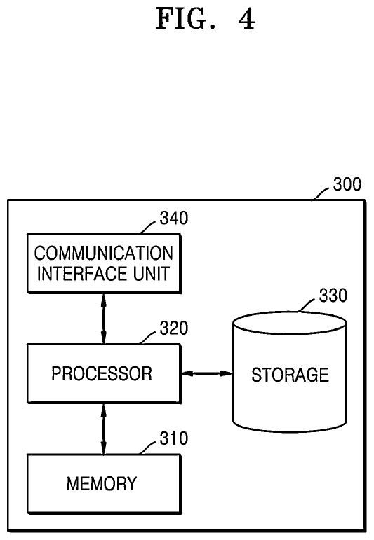

FIG. 4 is a diagram for describing a configuration and an operation of the charging station information providing server 300.

Referring to FIG. 4, the charging station information providing server 300 includes a memory 310, a processor 320, a storage 330, and a communication interface unit 340. Those of skill in the art to which the present disclosure pertains may understand that other general-purpose components may be further included in addition to the components illustrated in FIG. 4.

Each component of the block diagram of FIG. 4 may be separated, added, or omitted depending on the implementation method of the charging station information providing server 300. That is, depending on the implementation method, one component may be subdivided into two or more components, two or more components may be combined into one component, or some components may be added or removed.

The memory 310 may store instructions executable by the processor 320. The memory 310 may store software or a program.

The processor 320 may execute the instructions stored in the memory 310. The processor 320 may perform overall control of the charging station information providing server 300. The processor 320 may receive a request or various pieces of information from an external device through the communication interface unit 340, and store the received information in the storage 330. In addition, the processor 320 may process the received information. For example, the processor 320 may receive road condition information from the road information providing server 400, or information about a charging station from the charging station operator server 500. The processor 320 may perform processing to manage the received information and store a result of the processing in the storage 330. In addition, in response to a request received from the vehicle 100 or the user terminal 200, the processor 320 may transmit charging station information or customized recommended charging station information to the vehicle 100 or the user terminal 200 through the communication interface unit 340 by using information stored in the storage 330.

The storage 330 may store a variety of software and information necessary for the charging station information providing server 300 to provide charging station information. For example, the storage 330 may store programs and applications executable by the charging station information providing server 300, and various pieces of data or information used for a charging service. The storage 330 may store information received from the vehicle 100, the user terminal 200, the road information providing server 400, the charging station operator server 500, and the like.

The storage 330 may store and manage user information in a database for each user, or may store and manage vehicle information in a database for each vehicle 100. User information and vehicle information may be matched to user identification information and then stored. A plurality of vehicles that are matched to user identification information and then registered may be distinguished by vehicle identification information.

The storage 330 may store and manage information about charging stations, such as charging station-specific information or charging station status information, in a database for each charging station. The charging station-specific information refers to information that does not change even when the charging station is used, such as identification information of the charging station, the location of the charging station, a charging port type or a charging speed. The charging station status information refers to information that may change depending on the use of the charging station, such as usage status information of a charger or whether a charger is lost.

As such, the information stored in the storage 330 may be converted into big data and used for a charging station information providing service through various types of algorithms, analysis models, statistical models, evaluation models, recommendation models, and the like.

For example, the processor 320 may analyze information such as the user's favorite places, travel routes, or vehicle usage times through driving information records of the user, and identify payment method information such as a charging membership card or a charging payment card that is frequently used by the user.

As another example, the processor 320 may convert battery status information of the vehicle 100 into big data, to predict information such as battery charge/discharge cycle information, a time point when a battery needs to be charged, battery output efficiency, information about an expected lifespan of the battery, or a time to replace the battery.

As another example, the processor 320 may calculate a usage congestion level according to a statistical model based on periodically collected usage status information of a charging station, or may predict an expected charging station waiting time through an analysis model. In addition, the processor 320 may determine charging station list information according to charging station evaluation results indicating the reliability of charging stations, by using a charging station evaluation model based on usage status information and environment information of the charging stations.

In addition, the storage 330 may store and manage advertisement information about places or facilities near a charging station. When charging station information or recommended charging station information is provided, an advertisement stored in the storage 330 may be provided along with advertisement information about places or facilities near a charging station.

The communication interface unit 340 may communicate with the vehicle 100, the user terminal 200, the road information providing server 400, the charging station operator server 500, and the like. For example, the charging station information providing server 300 may receive, from the user terminal 200, user information such as condition information for customized recommendation, or vehicle information such as a vehicle account, or receive information about a charging station from the charging station operator server 500, and may provide charging station information in response to a request from an external device.

The charging station information providing server 300 may include a load balancing server and functional servers for providing a charging station information providing service. For example, the functional servers may include a charging station information providing service reception server, a database management server, a customized recommended charging station determination server, and the like. The charging station information providing server 300 may include a plurality of servers divided by function, or may be an integrated server.

The processor 320 may execute the instructions stored in the memory 310 to perform the following operations. According to an embodiment, the processor 320 may receive a charging station recommendation request from an external device through the communication interface unit 340, and in response to the received charging station recommendation request, obtain customized recommended charging station information. For example, the processor 320 may generate a charging station recommendation query based on user information and vehicle information that are stored in the storage 330 and correspond to a user of the external device, and obtain customized recommended charging station information based on charging station list information obtained by using the charging station evaluation model, and road condition information, by using a charging station recommendation model that takes the generated charging station recommendation query as input. The processor 320 may transmit the obtained customized recommended charging station information to the external device through the communication interface unit 340.

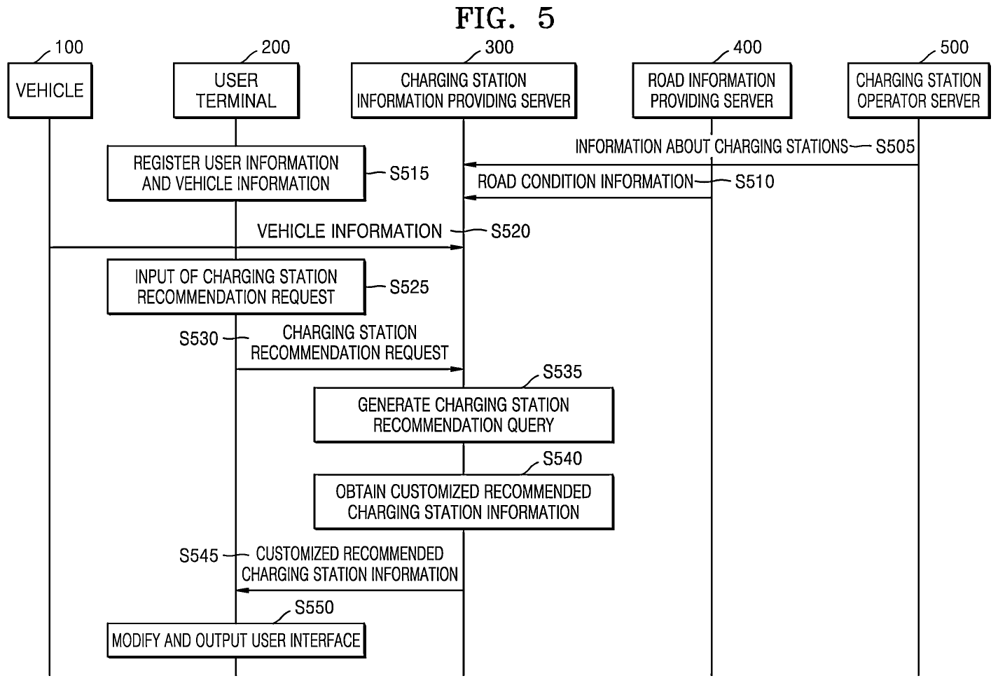

FIG. 5 is a diagram for describing a process of providing customized recommended charging station information in response to a charging station recommendation request.

The charging station operator server 500 may transmit information about charging stations to the charging station information providing server 300 (S505). For example, the charging station operator server 500 may transmit charging station status information that changes according to users' use of the charging station, to the charging station information providing server 300 in real time or periodically. Accordingly, the charging station information providing server 300 may collect the information about the charging stations. The charging station information providing server 300 may collect information about charging stations from an information intermediation server that collects and provides usage status of charging stations located within a particular area, or from the user terminal 200, rather than from the charging station operator server 500.

The charging station information providing server 300 may manage the information about the charging stations. The charging station information providing server 300 may store and manage charging station-specific information, charging station status information, and charging station evaluation information for each charging station, in a database. For example, the charging station information providing server 300 may obtain and manage charging station evaluation information indicating the reliability of a charging station based on usage status information of the charging station and environmental information of the charging station. The usage status information of the charging station may include a rate of use or a frequency of use of the charging station during a certain time period, recent usage information, a usage congestion level, or the like. The charging station information providing server 300 may calculate a usage congestion level or predict an expected waiting time through a statistical model, an analysis model, an algorithm, or the like, by reflecting the updated charging station status information. The environment information of the charging station is information related to the building or location where the charging station is located, and may include operating hour information, whether visitor access is restricted, parking fees, difficulty of entering a parking lot, and the like. The reliability of the charging station indicates the probability that the charging station is available to the user.

The road information providing server 400 may transmit road condition information to the charging station information providing server 300 (S510). For example, the road information providing server 400 may transmit detailed road information or traffic situation information that changes over time, to the charging station information providing server 300 in real time or periodically. Accordingly, the charging station information providing server 300 may collect, store, and manage the road condition information.

The user terminal 200 may register user information and vehicle information (S515). When user information and vehicle information are transmitted to the charging station information providing server 300, they may be stored and managed in a database of the charging station information providing server 300. User information or vehicle information, which is generated or modified each time the charging station information providing service is used, may be updated in the database.

The user terminal 200 may receive settings of user information and vehicle information through a user setting menu in a user interface upon execution of the charging station information providing application, and register them in the charging station information providing server 300.

When subscribing to a service to use or subscribe to the charging station information providing service, the user may register basic information of the user, charging-related condition information, or basic information of a vehicle as user information. Based on the basic information of the user or the basic information of the vehicle, the user may be classified as a certain group, and group characteristic information of the group to which the user belongs may be registered as user information. For example, the user may be classified as a certain group according to whether the user has subscribed to the charging station information providing service, the driving experience of the user, information about the model of the vehicle 100, and the like.

As the charging station information providing service is used, more information may be registered as user information or vehicle information in the charging station information providing server 300. User pattern information identified from the user information accumulated while using the charging station information providing service, or repeatedly set usage information may serve as personal characteristic information of the user. For example, personal characteristic information, for example, i) driving information of the user such as the user's favorite places or travel routes, the user's travel times, destinations or stopovers set by the user, ii) charging-related information such as a charging port type and a charging speed, charging fees, or additional services, and iii) payment method information, may be registered as user information.

The charging station information providing server 300 may receive vehicle information from the vehicle 100 or an external server that provides information about the vehicle 100 (S520). For example, the charging station information providing server 300 may receive the vehicle information through a vehicle information providing API by using a vehicle account registered by the user. When there is a request for a charging station search or recommendation, or when there is a change in the vehicle information as the vehicle 100 is driven, the charging station information providing server 300 may access the vehicle 100 or an external server that provides information about the vehicle 100 in order to obtain vehicle information.

In a case in which the charging station information providing server 300 obtains vehicle information from the external server that provides vehicle information, such as a vehicle manufacturer server, the vehicle account registered by the user may be linked to the external server that provides vehicle information. The charging station information providing server 300 may request the external server to confirm whether the linkage to the vehicle account is valid, and the external server may confirm whether the linkage to the vehicle account is valid. When the vehicle account transmitted by the charging station information providing server 300 matches the vehicle account registered in the external server, the validity of the vehicle account may be confirmed. The charging station information providing server 300 may encrypt and store the linked vehicle account.

The user terminal 200 may receive an input of a charging station recommendation request from the user interface upon execution of the charging station information providing application (S525). The input of the charging station recommendation request may include a selection of condition information for customized recommendation.

The user terminal 200 may transmit the charging station recommendation request to the charging station information providing server 300 (S530). Here, the charging station recommendation request may include at least one of user identification information and vehicle identification information. In addition, when there is condition information for customized recommendation during the process of inputting the charging station recommendation request, the user terminal 200 may transmit, to the charging station information providing server 300, the charging station recommendation request further including the condition information. For example, the user terminal 200 may transmit, to the charging station information providing server 300, the charging station recommendation request including information about a location where the vehicle is to be charged, information about a time when the vehicle is to be charged, and charging-related condition information. Location information of the user terminal 200 may be included in the charging station recommendation request and then transmitted, or may be transmitted to the charging station information providing server 300 in real time or periodically. The location information may be manually specified by the user, or current location information may be automatically specified by using the location sensor of the user terminal 200.

The charging station information providing server 300 may generate a charging station recommendation query based on the user information and the vehicle information both corresponding to the user of the user terminal 200 (S535). After receiving the charging station recommendation request from the user terminal 200, the charging station information providing server 300 may generate a charging station recommendation query by using the information included in the charging station recommendation request. The charging station information providing server 300 may generate a charging station recommendation query based on the user information and the vehicle information obtained from the charging station information providing server 300 by using at least one of the user identification information and the vehicle identification information included in the charging station recommendation request, or generate a charging station recommendation query further based on the condition information for customized recommendation included in the charging station recommendation request.

For example, the charging station information providing server 300 may generate a charging station recommendation query based on user information corresponding to the user identification information included in the charging station recommendation request, and vehicle information of the vehicle that is matched to user identification information and then registered. As another example, the charging station information providing server 300 may generate a charging station recommendation query based on the user information corresponding to the user identification information, and vehicle information of a vehicle corresponding to the vehicle identification information from among vehicles that are matched to user identification information and then registered, according to the user identification information and the vehicle identification information included in the charging station recommendation request.

The charging station information providing server 300 may obtain customized recommended charging station information by using a charging station recommendation model that takes the generated charging station recommendation query as input (S540). For example, the charging station information providing server 300 may determine customized recommended charging station information based on charging station list information obtained by using a charging station evaluation model, and road condition information, by using a charging station recommendation model. A customized recommended charging station may be a charging station optimized for the user, which is determined based on user information, vehicle information, information about charging stations, and road condition information. The user information or the vehicle information corresponds to the user of the user terminal 200, and may be stored for each user in the charging station information providing server 300 or may be included in the charging station recommendation request received from the user terminal 200. The information about the charging stations or the road condition information may correspond to location information received from the user terminal 200. The information about the charging stations may be charging station-specific information, charging station status information, and charging station evaluation information stored for each charging station in the charging station information providing server 300.

When a plurality of external devices, including the user terminal 200, simultaneously access the charging station information providing server 300, the charging station information providing server 300 may provide load-balanced charging station information. The charging station information providing server 300 may replace the highest-priority customized recommended charging station information with lower-priority customized recommended charging station information, based on at least one of the number of real-time views of a charging station, a history of transmission of customized recommended charging station information within a certain time period, and the density of the locations of external devices connected to the charging station information providing server.

For example, when the charging station information providing server 300 has determined charging station ‘A’ as a customized recommended charging station in response to a charging station recommendation request from the user terminal 200, but before the determination, the charging station information providing server 300 has transmitted charging station ‘A’ as customized recommended charging station information to other external devices more than a certain number of times, the charging station information providing server 300 may transmit, to the user terminal 200, charging station ‘B’ corresponding to the next recommendation priority as customized recommended charging station information. As another example, when the charging station information providing server 300 has determined charging station ‘A’ as a customized recommended charging station in response to a charging station recommendation request from the user terminal 200, but the number of real-time views of charging station ‘A’ from other external devices rapidly increases beyond a certain level, or the current locations of other external devices are concentrated above a certain level in the area where charging station ‘A’ is located, the charging station information providing server 300 may transmit, to the user terminal 200, charging station ‘B’ corresponding to the next recommendation priority as customized recommended charging station information.

The charging station information providing server 300 may transmit the customized recommended charging station information to the user terminal 200 (S545). The charging station information providing server 300 may classify the customized recommended charging station information into categories corresponding to charging station type information and transmit it to the user terminal 200. The user terminal 200 may receive the customized recommended charging station information from the charging station information providing server 300.

The user terminal 200 may modify and output the user interface based on the received customized recommended charging station information (S550). For example, the user terminal 200 may output a map-based user interface that reflects the received customized recommended charging station information. Here, the user terminal 200 may select only the customized recommended charging station information corresponding to a particular category selected by the user, and output it on the user interface. Accordingly, the user may obtain information about a charging station optimized for the user in the current location, a particular area, or a travel route.

The charging station information providing server 300 may receive a request for route guidance to a customized recommended charging station based on customized recommended charging station information from an external device such as the user terminal 200, and in response to the received route guidance request, provide the external device with a travel route to the customized recommended charging station based on road condition information.

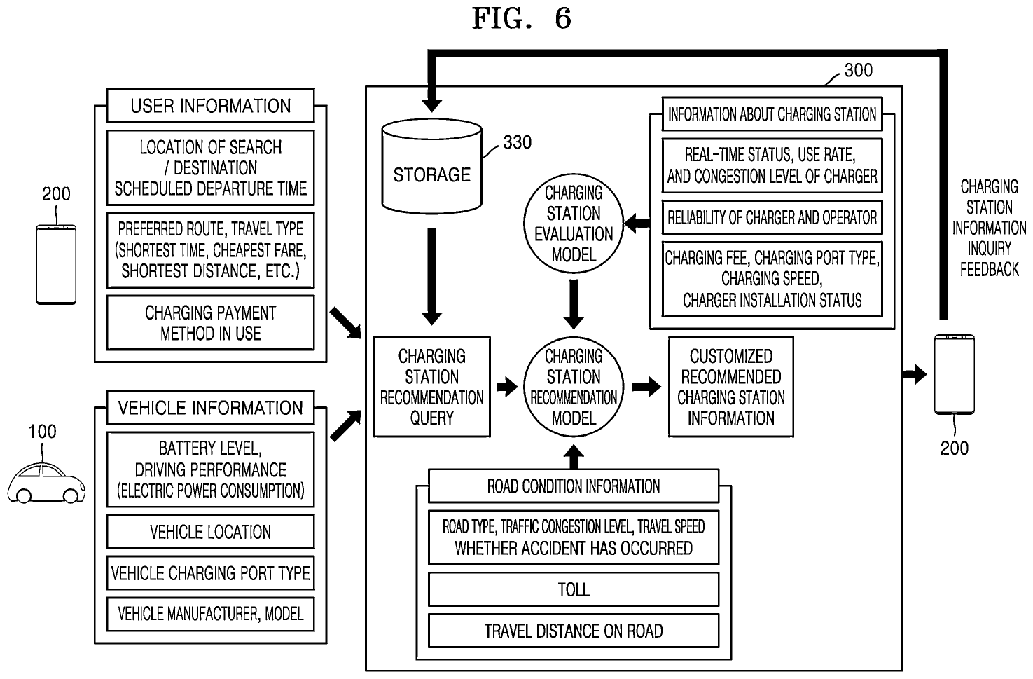

FIG. 6 is a diagram for describing a process of obtaining customized recommended charging station information.

The charging station information providing server 300 may generate a charging station recommendation query based on user information and vehicle information, and obtain customized recommended charging station information based on charging station list information obtained by using the charging station evaluation model, and road condition information, by using the charging station recommendation model that takes the generated charging station recommendation query as input. Here, the charging station recommendation query may be generated based on information about a charging station type preferred by the user, by reflecting charging station information inquiry feedback.

Referring to FIG. 6, the charging station information providing server 300 may obtain user information and vehicle information. The user information or the vehicle information may be stored in a database in the charging station information providing server 300, and may be obtained by using user identification information or vehicle identification information. The user information may be information input when using the charging station information providing service, such as a charging station recommendation request or search request from the user terminal 200, or may be user pattern information or user preference information identified from such information. For example, the user information may be a destination or location information input by the user when using the charging station information providing service, or a preferred travel route and travel type identified therefrom. The vehicle information may be unique information of the vehicle 100, may be information that changes according to driving of the vehicle 100, or may be vehicle pattern information identified from such information. For example, the vehicle information may include vehicle charging port type information, vehicle location information, battery level information, battery charge/discharge cycle information, and driving performance information such as electric power consumption.

The charging station information providing server 300 may generate a charging station recommendation query based on user information and vehicle information obtained by using at least one of user identification information and vehicle identification information included in the charging station recommendation request. In order to determine a customized recommended charging station, a charging station recommendation query that reflects the status or characteristics of the user and the vehicle may be generated. For example, the charging station information providing server 300 may obtain, from the storage 330, user information corresponding to the user identification information, and vehicle information of a vehicle that is matched to the user identification information and then registered, by using the user identification information included in the charging station recommendation request, and generate a charging station recommendation query. As another example, the charging station information providing server 300 may obtain, from the storage 330, user information corresponding to the user identification information, and vehicle information of a vehicle corresponding to the vehicle identification information from among vehicles that are matched to user identification information and then registered, by using the user identification information and the vehicle identification information included in the charging station recommendation request, and generate a charging station recommendation query.

The charging station information providing server 300 may generate a charging station recommendation query further based on condition information for customized recommendation included in the charging station recommendation request. In a case in which the user has registered condition information for customized recommendation in advance, the condition information included in the charging station recommendation request may be used to generate a charging station recommendation query, instead of the condition information registered in the storage 330 of the charging station information providing server 300.

The charging station information providing server 300 may input, into an algorithm or a generation model for generating a charging station recommendation query, at least one of the user's preferred location or travel route, vehicle usage time, information about the user's payment method, a charging speed, a charging price range, parking fees of a parking lot where a charging station is located, characteristics of the location where the charging station is installed, battery level information, battery charge/discharge cycle information, a time point when a battery needs to be charged, and a time to replace the battery. Accordingly, the charging station information providing server 300 may generate a charging station recommendation query that reflects the status or characteristics of the user and the vehicle.

The charging station information providing server 300 may obtain information about charging stations and road condition information. The information about the charging stations may include charging station-specific information, charging station status information, and charging station evaluation information for each charging station. The charging station information providing server 300 may obtain road condition information. The road condition information may include detailed road information, transportation facility usage costs, a travel distance on a road, and the like.

Based on the information about the charging stations, the charging station information providing server 300 may determine charging station list information according to a charging station evaluation result indicating the reliability of the charging stations based on usage statistics of the charging stations, the percentage of normally operating charging stations for each business operator, and the like, by using the charging station evaluation model. The charging station information providing server 300 may filter charging stations available to the user by using the charging station evaluation model. The charging station evaluation model may output a value for each charging station that indicates whether the charging station is available to the user, by using, as input, usage status information and environment information of each charging station, and business operator information.

The charging station information providing server 300 may obtain customized recommended charging station information based on the charging station list information filtered by using the charging station evaluation model, and the road condition information, by using the charging station recommendation model that takes the charging station recommendation query as input. The charging station information providing server 300 may generate a charging station recommendation query by using user information in which application weights of group characteristic information of a group to which the user belongs and personal characteristic information of the user are adjusted according to the user's cumulative use of the charging station information providing service, and obtain customized recommended charging station information by using the charging station recommendation model that takes the generated charging station recommendation query as input.

The charging station recommendation model may output a value for each charging station that indicates the degree to which the charging station matches the status of the user and vehicle 100 and condition information of a road and the charging station, by reflecting the user information, the vehicle information, information about the charging station and the road. The charging station information providing server 300 may determine customized recommended charging station information according to a result of applying the charging station recommendation model.

In addition, the charging station recommendation model may take, as input, a charging station recommendation query that reflects information about a charging station type preferred by the user, according to charging station information inquiry feedback from the user about the customized recommended charging station information. The charging station information providing server 300 may learn information about a charging station type preferred by the user, and thus increase the recommendation strength for a charging station corresponding to the information about the charging station type preferred by the user when providing a customized recommended charging station. The user terminal 200 may transmit the charging station information inquiry feedback to the charging station information providing server 300, and the charging station information providing server 300 may store the charging station information inquiry feedback in the storage 330, and then, when there is a charging station recommendation request, provide customized recommended charging station information reflecting the information about the charging station type preferred by the user. In a case in which the user has no history of using the charging station information providing service or has a history of using the service below a certain criterion, information about a charging station type preferred by users in the group to which the user belongs may be retrieved from the storage 330 and reflected in generating a charging station recommendation query.

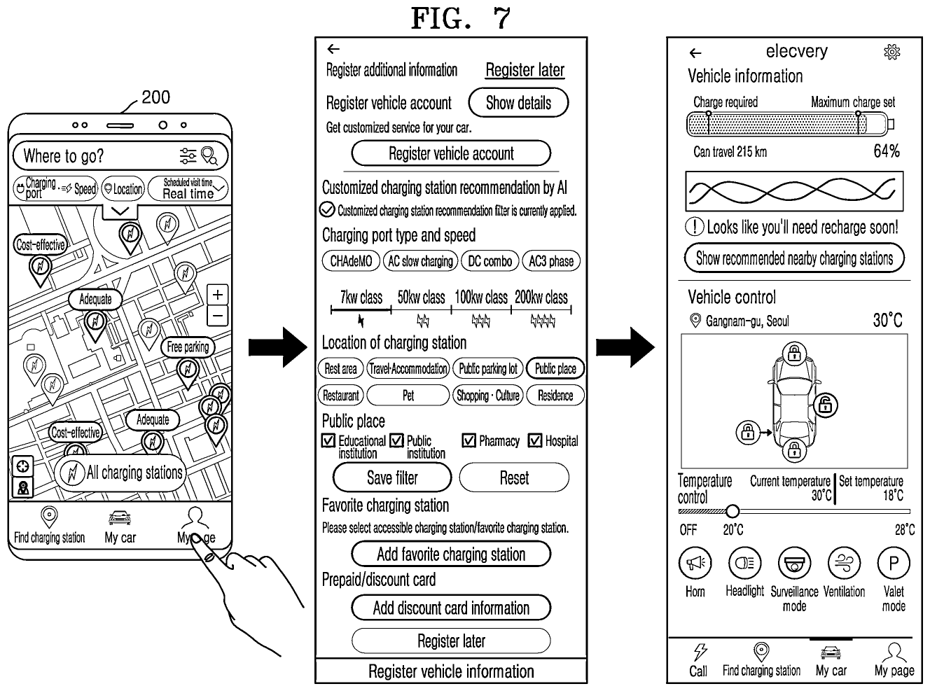

FIG. 7 is a diagram illustrating an example of registering user information and vehicle information on a user interface upon execution of a charging station information providing application.

Referring to FIG. 7, the user terminal 200 may pre-register user information and vehicle information for using the charging station information providing service, through a user setting menu (‘My page’) in a user interface upon execution of the charging station information providing application.

For example, as illustrated in FIG. 7, the user terminal 200 may register particular conditions according to the user's settings for a charging port type, a charging speed, information about a location where the vehicle is to be charged, and the like corresponding to charging-related condition information. The particular conditions registered in this way may be used by the charging station information providing server 300 to filter charging stations. The user terminal 200 may further register favorite charging stations, prepaid/discount card information, parking fee information, and the like.

The user terminal 200 may register a vehicle account. The charging station information providing server 300 may receive vehicle information through a vehicle information providing API by using a vehicle account registered by the user, and store the vehicle information in the storage 330. The charging station information providing server 300 may receive vehicle information in the storage 330 and update it when there is a charging station search or recommendation request, when the vehicle 100 is in operation, or periodically. The charging station information providing server 300 may predict information necessary for use or management of the vehicle 100 based on vehicle information accumulated within a certain time period. For example, the charging station information providing server 300 may predict information such as battery charge/discharge cycle information, a required battery charge, battery power consumption, a time to replace the battery, and the like, from battery status information of the vehicle 100.

The user terminal 200 may register or check vehicle information and set information for vehicle control and management through a vehicle information menu (‘My car’) in a user interface upon execution of the charging station information providing application. The charging station information providing server 300 may utilize the vehicle information registered through the user terminal 200, for the charging station information providing service.

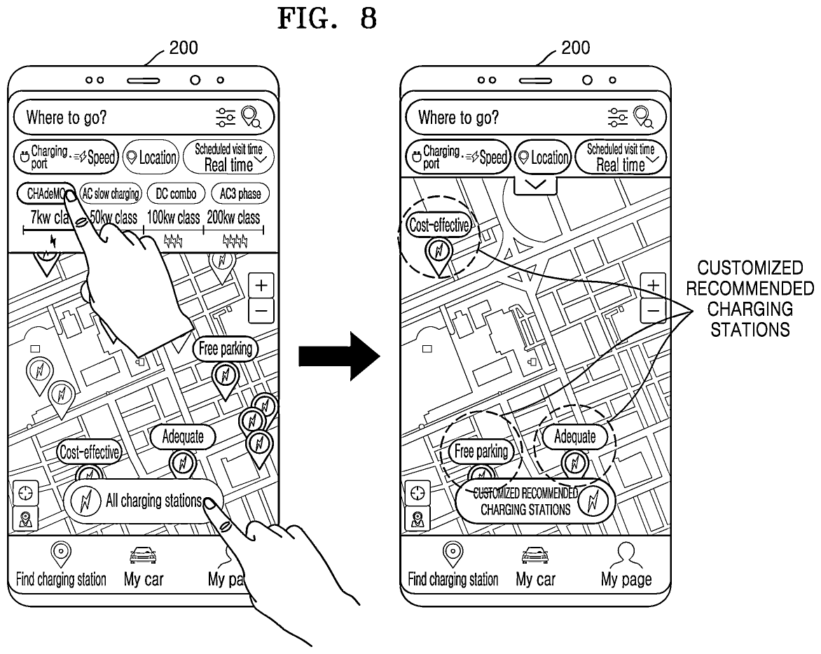

FIG. 8 is a diagram illustrating an example of providing customized recommended charging station information in response to a charging station recommendation request in a user interface upon execution of a charging station information providing application.

Referring to FIG. 8, the user terminal 200 may provide a user interface for selecting charging-related condition information such as the type or speed of a charging port, information about a location where the vehicle is to be charged, or information about a time when the vehicle is to be charged. After the selection of condition information for customized recommendation is completed, when a charging station recommendation request is input, the user terminal 200 may transmit a charging station recommendation request including the selected condition information to the charging station information providing server 300. The user terminal 200 may detect an input of a charging station recommendation request in response to a user input of swiping or tapping a ‘Charging station recommendation request’ button (or a ‘Show customized recommended charging stations’ button, but its name is not limited) on a map-based user interface.

The user terminal 200 may receive, from the charging station information providing server 300, customized recommended charging station information in response to the transmitting of the charging station recommendation request including the selected condition information to the charging station information providing server 300, and modify and output the user interface. For example, as illustrated in FIG. 8, the user terminal 200 may provide the locations and information of all charging stations around the current location, and then, when there is a charging station recommendation request from the user, modify the user interface to provide only customized recommended charging station information. The customized recommended charging station information is determined by using various pieces of information stored in the charging station information providing server 300 as well as the condition information for customized recommendation included in the charging station recommendation request, and may include information about at least one charging station.

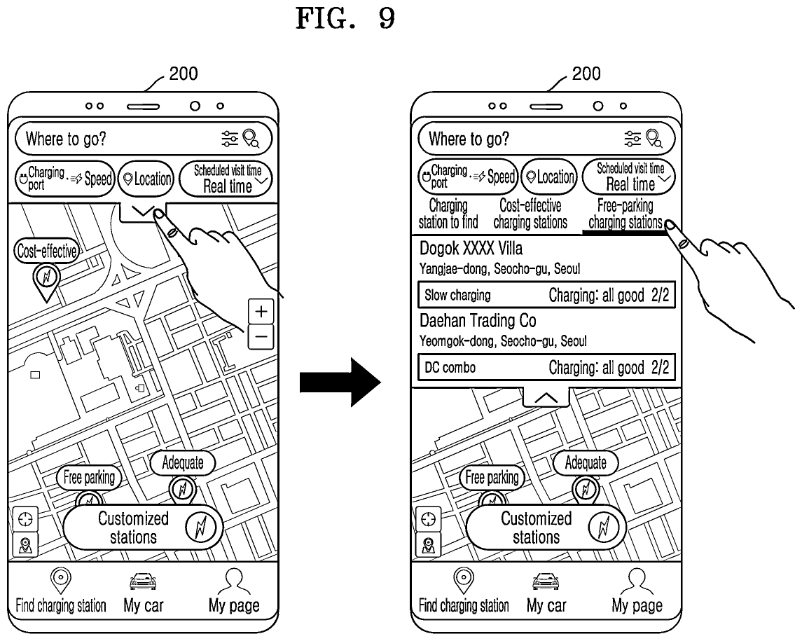

FIG. 9 is a diagram illustrating an example of confirming customized recommended charging station information for each category corresponding to charging station type information in a user interface upon execution of a charging station information providing application.

Referring to FIG. 9, on a user interface that outputs customized recommended charging station information, the user terminal 200 may classify the customized recommended charging station information into categories corresponding to charging station type information, and modify and output the user interface. As illustrated in FIG. 9, the charging station type information may be free-parking charging station, adequate charging station, cost-effective charging station, or the like, and when the user selects any one of them, the user terminal 200 may modify and output the customized recommended charging station information corresponding to the selected category, along with detailed information, on the user interface.

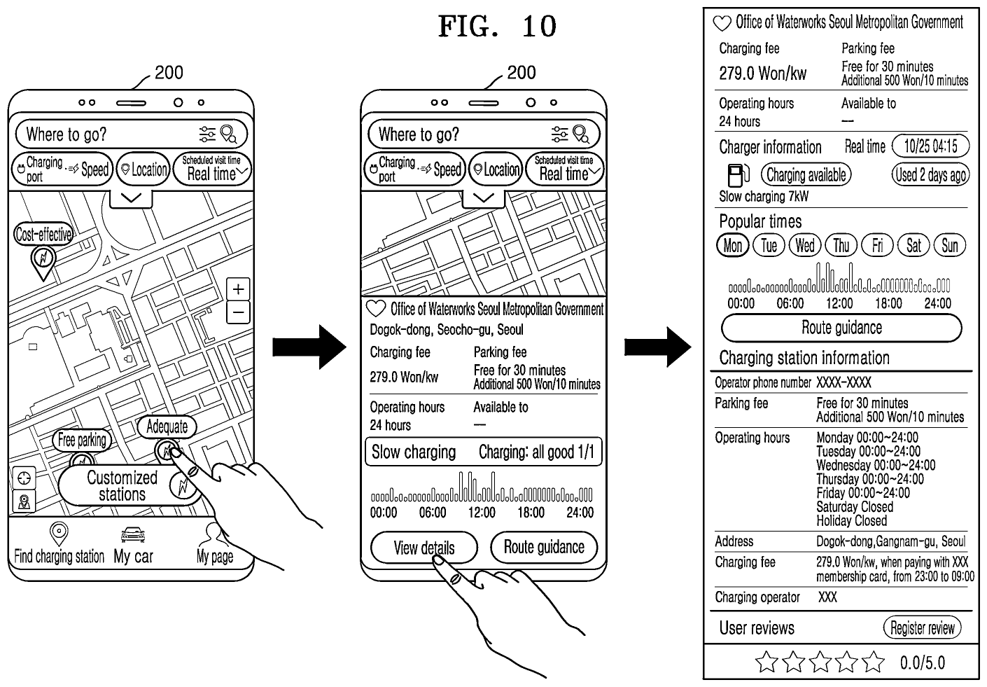

FIG. 10 is a diagram illustrating an example of checking detailed information of customized recommended charging station information in a user interface upon execution of a charging station information providing application.

Referring to FIG. 10, when the user taps an icon of a particular charging station, the user terminal 200 may provide a banner-style user interface element that simply displays key information such as the name, charging fee, parking fee, charging speed, and usage congestion level of the charging station. The usage congestion level may be displayed in the form of a bar graph indicating the level of congestion by hour such that statistical congestion levels within a certain time period (e.g., 24 hours) may be compared at a glance.

When there is a tap input on a ‘View details’ button in the user interface element, the user terminal 200 may additionally provide more detailed information, route guidance to the charging station, user review information for the charging station, and the like.

For example, the user terminal 200 may transmit, to the charging station information providing server 300, a request for route guidance to a certain customized recommended charging station, based on the customized recommended charging station information. The charging station information providing server 300 may receive, from the user terminal 200, the request for route guidance to the customized recommended charging station. In response to the received request for route guidance, the charging station information providing server 300 may provide the user terminal 200 with a travel route to the customized recommended charging station based on road condition information. The user terminal 200 may receive, from the charging station information providing server 300, the travel route to the customized recommended charging station and output the travel route on the user interface.

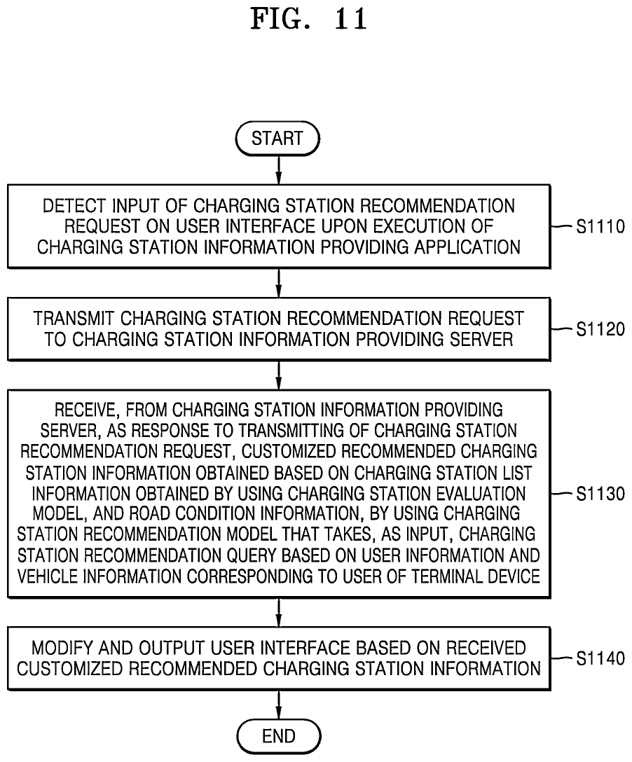

FIG. 11 is a flowchart of a charging station information providing method upon execution of a charging station information providing application of a terminal device.

A terminal device such as the vehicle 100 or the user terminal 200 may perform the charging station information providing method upon execution of the charging station information providing application. Hereinafter, terms and descriptions that are provided above will be omitted.

The terminal device may detect an input of a charging station recommendation request on a user interface upon execution of the charging station information providing application (S1110). Here, the terminal device may further detect an input for setting condition information for customized recommendation in the user interface.

For example, the terminal device may detect an input of a charging station recommendation request corresponding to current location information, in response to a user input of swiping or tapping a charging station recommendation request button on a map-based user interface. As another example, the terminal device may detect an input of a charging station recommendation request including condition information about a location, in response to a user input of setting location information on a map-based user interface. As another example, the terminal device may detect an input of a charging station recommendation request including condition information about a travel route, in response to a user input of setting a travel route and then swiping of tapping a charging station recommendation request button on the map-based user interface. As another example, the terminal device may detect an input of a charging station recommendation request including condition information about a scheduled departure time.

The terminal device may transmit the charging station recommendation request to the charging station information providing server 300 (S1120). Here, the terminal device may transmit, to the charging station information providing server 300, the charging station recommendation request including at least one of user identification information and vehicle identification information, and condition information for customized recommendation. For example, the terminal device may transmit, to the charging station information providing server 300, the charging station recommendation request including information about a location where the vehicle is to be charged, information about a time when the vehicle is to be charged, and charging-related condition information, which are selected by the user.

The terminal device may receive, from the charging station information providing server 300, in response to the transmitting of the charging station recommendation request, customized recommended charging station information obtained based on charging station list information obtained by using a charging station evaluation model, and road condition information, by using a charging station recommendation model that takes, as input, a charging station recommendation query based on user information and vehicle information corresponding to the user of the terminal device (S1130). For example, the terminal device may receive, as customized recommended charging station information, a charging station list including information about at least one charging station.

The terminal device may modify and output the user interface based on the received customized recommended charging station information (S1140). For example, the terminal device may modify and output the user interface to display information about each charging station included in the received customized recommended charging station information. The terminal device may classify the customized recommended charging station information into categories corresponding to charging station type information, and modify and output the user interface. Here, the terminal device may select only the customized recommended charging station information corresponding to a particular category selected by the user, and output it on the user interface. Accordingly, the user may obtain information about a charging station that the user prefers in the current situation.

When the user having checked the customized recommended charging station information inputs a route guidance request on the terminal device in order to move to a customized recommended charging station, the terminal device may transmit, to the charging station information providing server 300, a request for route guidance to the customized recommended charging station, based on the customized recommended charging station information. The terminal device may receive, from the charging station information providing server 300, a travel route to the customized recommended charging station based on road condition information in response to the request for route guidance, and output the travel route on the user interface.

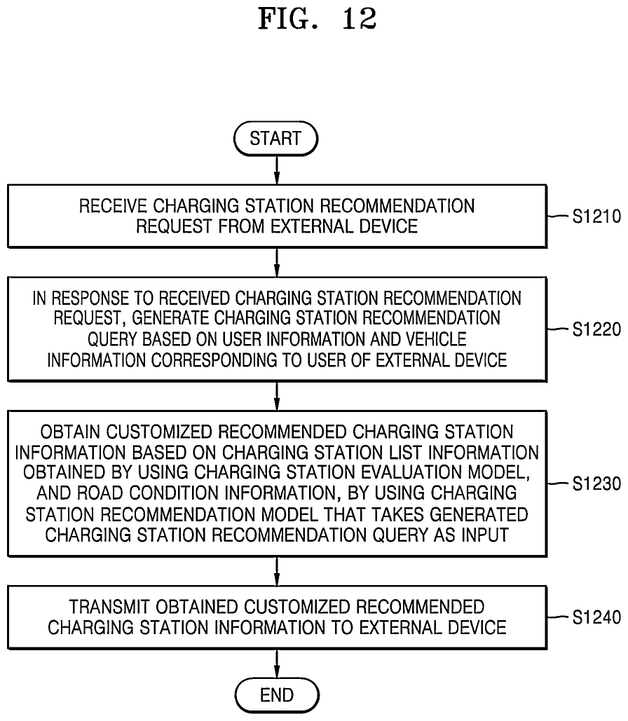

FIG. 12 is a flowchart of a charging station information providing method performed by the charging station information providing server 300.

The charging station information providing server 300 may perform the charging station information providing method. Hereinafter, terms and descriptions that are provided above will be omitted. In order to provide a charging station information providing service, the charging station information providing server 300 may receive and store user information including at least one of driving information of the user, charging-related condition information, and payment method information from an external device, and receive and store vehicle information through a vehicle information providing API by using a vehicle account registered by the user. The external device may be the vehicle 100 or the user terminal 200, but is not limited thereto.

The charging station information providing server 300 may receive a charging station recommendation request from an external device (S1210). The charging station information providing server 300 may receive a charging station recommendation request including at least one of user identification information and vehicle identification information from the external device, or may receive a charging station recommendation request further including condition information from the external device.

In response to the received charging station recommendation request, the charging station information providing server 300 may generate a charging station recommendation query based on the user information and the vehicle information corresponding to the user of the external device (S1220). For example, in a case in which the user has registered one vehicle in the charging station information providing server 300, the charging station information providing server 300 may generate a charging station recommendation query based on user information corresponding to user identification information included in the charging station recommendation request, and vehicle information of the vehicle that is matched to the user identification information and then registered. As another example, when the user has registered a plurality of vehicles in the charging station information providing server 300, the charging station information providing server 300 may generate a charging station recommendation query based on user information corresponding to user identification information, and vehicle information of a vehicle corresponding to vehicle identification information from among vehicles that are matched to the user identification information and then registered, based on the user identification information and the vehicle identification information included in the charging station recommendation request.

The charging station information providing server 300 may obtain customized recommended charging station information based on charging station list information obtained by using a charging station evaluation model, and road condition information, by using a charging station recommendation model that takes the generated charging station recommendation query as input (S1230). The charging station information providing server 300 may use the charging station evaluation model to determine charging station list information according to a charging station evaluation result indicating the reliability of charging stations, based on usage status information of the charging stations and environment information of the charging stations. The charging station list information obtained by using the charging station evaluation model may correspond to a result of filtering out charging stations that are unavailable to the user.

The charging station information providing server 300 may generate a charging station recommendation query by using user information in which application weights of group characteristic information of a group to which the user belongs and personal characteristic information of the user are adjusted according to the user's cumulative use of the charging station information providing service, and obtain customized recommended charging station information by using the charging station recommendation model that takes the generated charging station recommendation query as input. Because the experience of the user in using the charging station information providing service is insufficient at the beginning, group characteristic information of a group with similar characteristics to the user may be adjusted to be more reflected in the user information. As the use of the charging station information providing service accumulates, personal characteristic information of the user may be adjusted to be more reflected in the user information.

In order to prevent recommendations from being concentrated on a particular charging station, the charging station information providing server 300 may replace the highest-priority customized recommended charging station information with lower-priority customized recommended charging station information, based on at least one of the number of real-time views of a charging station, a history of transmission of customized recommended charging station information within a certain time period, and the density of the locations of external devices connected to the charging station information providing server 300.

The charging station information providing server 300 may transmit the obtained customized recommended charging station information to the external device (S1240). The charging station information providing server 300 may classify the customized recommended charging station information into categories corresponding to charging station type information and transmit it to the external device. The charging station information providing server 300 may receive, from the external device, a request for route guidance to a customized recommended charging station based on the customized recommended charging station information in response to the transmitting of the customized recommended charging station information to the external device, and provide the external device with a travel route to the customized recommended charging station based on road condition information.

Each of the above-described embodiments may be provided in the form of a computer program or an application stored in a medium in order to cause a terminal device of an external device such as the vehicle 100 or the user terminal 200, to execute certain operations for performing the charging station information providing method. In addition, each of the above-described embodiments may be provided in the form of a computer program or an application stored in a medium in order to cause the charging station information providing server 300 to execute certain operations for performing the charging station information providing method.

In other words, each of the above-described embodiments may be provided in the form of a computer program or an application stored in a medium, to cause at least one processor of a terminal device of an external device, such as the vehicle 100 or the user terminal 200, to perform certain operations for performing the charging station information providing method. In addition, each of the above-described embodiments may be provided in the form of a computer program or an application stored in a medium, to cause at least one processor of a server to execute certain operations for performing the charging station information providing method.

The above-described embodiments may be implemented in the form of a computer-readable storage medium storing instructions executable by a computer or a processor, and data. At least one of the instructions and the data may be stored in the form of program code, and when executed by a processor, a certain program module may be generated to perform a certain operation. Such computer-readable storage media may include read only memory (ROM), random access memory (RAM), flash memory, compact disc ROMs (CD-ROMs), CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing instructions or software, associated data, data files, and data structures, and providing the instructions or software, associated data, data files, and data structures to a processor or a computer such that the processor or computer may execute the instructions.

The embodiments have been described above. It will be understood by those of skill in the art to which the embodiments disclosed herein pertain that the present disclosure may be implemented in a modified form without departing from the intrinsic characteristics of the embodiments. Therefore, the disclosed embodiments are to be considered in a descriptive sense only, and not for purposes of limitation. The scope of the present disclosure is in the claims rather than the descriptions of the embodiments, and all differences within the equivalent scope should be construed as being included in the scope of the present disclosure.

1. A charging station information providing server comprising:
a storage;
a communication interface unit;
a memory storing instructions; and
a processor configured to execute the instructions to receive a charging station recommendation request from an external device through the communication interface unit, generate, in response to the received charging station recommendation request, a charging station recommendation query based on user information and vehicle information stored in the storage and corresponding to a user of the external device, obtain customized recommended charging station information based on charging station list information obtained by using a charging station evaluation model, and road condition information, by using a charging station recommendation model that takes the generated charging station recommendation query as input, and transmit the obtained customized recommended charging station information to the external device through the communication interface unit.

2. The charging station information providing server of claim 1, wherein the processor is further configured to execute the instructions to generate the charging station recommendation query further based on the user information and the vehicle information both obtained by using at least one of user identification information and vehicle identification information included in the charging station recommendation request, and condition information for customized recommendation included in the charging station recommendation request.

3. The charging station information providing server of claim 1, wherein the charging station evaluation model is used to determine the charging station list information according to a charging station evaluation result indicating reliability of a charging station, based on usage status information of the charging station and environment information of the charging station.

4. The charging station information providing server of claim 1, wherein the processor is further configured to execute the instructions to obtain the customized recommended charging station information by using the user information in which application weights of group characteristic information of a group to which the user belongs and personal characteristic information of the user are adjusted according to the user's cumulative use of a charging station information providing service.

5. The charging station information providing server of claim 1, wherein the processor is further configured to execute the instructions to replace the customized recommended charging station information with lower-priority customized recommended charging station information, based on at least one of the number of real-time views of a charging station, a history of transmission of the customized recommended charging station information within a certain time period, and density of locations of external devices connected to the charging station information providing server.

6. The charging station information providing server of claim 1, wherein the processor is further configured to execute the instructions to generate the charging station recommendation query based on the user information corresponding to user identification information included in the charging station recommendation request, and the vehicle information of a vehicle that is matched to the user identification information and then registered.

7. The charging station information providing server of claim 1, wherein the processor is further configured to execute the instructions to generate the charging station recommendation query based on the user information corresponding to user identification information and the vehicle information of a vehicle corresponding to vehicle identification information from among vehicles that are matched to the user identification information and then registered, according to the user identification information and the vehicle identification information included in the charging station recommendation request.

8. The charging station information providing server of claim 1, wherein the processor is further configured to execute the instructions to classify the customized recommended charging station information into categories corresponding to charging station type information, and transmit the classified customized recommended charging station information to the external device through the communication interface unit.

9. The charging station information providing server of claim 1, wherein the processor is further configured to execute the instructions to receive, from the external device, a request for route guidance to a customized recommended charging station based on the customized recommended charging station information, and in response to the received request for route guidance, provide the external device with a travel route to the customized recommended charging station based on the road condition information.

10. The charging station information providing server of claim 1, wherein the processor is further configured to execute the instructions to receive, from the external device through the communication interface unit, the user information comprising at least one of driving information of the user, charging-related condition information, and payment method information, store the user information in the storage, receive the vehicle information through a vehicle information providing application programming interface (API) by using a vehicle account registered by the user, and store the vehicle information in the storage.

11. A charging station information providing method performed by a charging station information providing server, the charging station information providing method comprising:
receiving a charging station recommendation request from an external device;
generating, in response to the received charging station recommendation request, a charging station recommendation query based on user information and vehicle information corresponding to a user of the external device;
obtaining customized recommended charging station information based on charging station list information obtained by using a charging station evaluation model, and road condition information, by using a charging station recommendation model that takes the generated charging station recommendation query as input; and
transmitting the obtained customized recommended charging station information to the external device.

12. A charging station information providing application stored in a medium to cause at least one processor of a terminal device to perform a charging station information providing method comprising:
detecting an input of a charging station recommendation request in a user interface upon execution of the charging station information providing application;
transmitting the charging station recommendation request to a charging station information providing server;
in response to the transmitting, receiving, from the charging station information providing server, customized recommended charging station information obtained based on charging station list information obtained by using a charging station evaluation model, and road condition information, by using a charging station recommendation model that takes, as input, a charging station recommendation query based on user information and vehicle information corresponding to a user of the terminal device; and
modifying and outputting the user interface based on the received customized recommended charging station information.

13. The charging station information providing application of claim 12, wherein the detecting further comprises detecting an input of setting condition information for customized recommendation in the user interface, and
The transmitting comprises transmitting the charging station recommendation request comprising at least one of user identification information and vehicle identification information, and the condition information for customized recommendation.

14. The charging station information providing application of claim 12, wherein the outputting comprises classifying the customized recommended charging station information into categories corresponding to charging station type information, and modifying and outputting the user interface.

15. The charging station information providing application of claim 12, wherein the charging station information providing method further comprises:
transmitting, to the charging station information providing server, a request for route guidance to a customized recommended charging station based on the customized recommended charging station information; and
in response to the transmitted request for route guidance, receiving, from the charging station information providing server, a travel route to the customized recommended charging station based on the road condition information.
